(19) United States
(12) Patent Application Publication
(10) Pub. No.: US 2002/0145221 A1
(43) Pub. Date: Oct. 10, 2002

(54) Machine and process for manufacturing recreational articles

(76) Inventors: Andrew F. Fireman, North Bethesda, MD (US); Thomas Eckert, Columbia, MD (US)

Correspondence Address: STEVEN N. FOX, ESQ, P.O. Box 251, CANTON, MA, 02021, US

(21) Appl. No.: 09/832,350

(22) Filed: Apr. 10, 2001

(51) Int. Cl. B29C 43/18

(52) U.S. Cl. 264/132; 264/138; 264/279.1; 264/322; 264/334; 425/508; 425/520

(57) ABSTRACT

The present invention is a machine and process for manufacturing an article such as a body board having a pre-shaped core member having a top surface and a bottom surface, a top skin having a top and bottom surfaces, a perimeter portion, and a perimeter edge, and a bottom skin having a perimeter portion. In one embodiment, the machine of the present invention comprises a first mold halve having a lower surface and a second mold halve having a lower surface and a plurality of side walls extending upward from the bottom surface. The second mold further comprising at least one seam member engaged with each side surface. The machine further comprises a control unit for opening and closing the first and second mold halves. In operation, when the first and second molds are closed, the top surface of the pre-defined core member is bonded to the top skin, the perimeter portion of the top skin is caused to compress and bond with the side rails of the pre-defined core member, and the perimeter edge of the top skin is caused to compress and bond to the perimeter portion of the bottom skin to form a seam. In a first embodiment, the process of the present invention comprises the steps of: (1) providing a first mold halve having a lower surface; (2) providing a second mold halve; (3) opening the first and second mold halves; (4) positioning in the first mold halve a pre-shaped core member having a top surface, a bottom surface having a bottom skin bonded thereto, and side rails; (5) positioning a top skin having an inner and outer surface in spaced relationship to the lower surface of the first mold halve; (6) heating, at substantially the same time, the top surface of the pre-shaped core member and the inner surface of the top skin; (7) closing the first and second mold halves; (8) compressing the top skin to the top surface and side rails of the pre-shaped core member; and (9) opening the upper and lower mold halves to remove the article.

### FIELD OF THE INVENTION

The present invention relates to machines and process for making body boards and kick boards.

### BACKGROUND OF THE INVENTION

Body boards and kick boards are widely used today by children and adults in a variety of aquatic recreational activities, such as riding a wave in an ocean or simply floating, kicking and paddling in a swimming pool. Body boards and kick board typically include a core body having an upper skin, or deck, a bottom skin which in use would be in contact with the water, and side rails each having an outer skin, all designed to maximize the performance characteristics of the board. Such performance characteristics, include, a durability and controlled flexion of the board, reduction of drag coefficients between the bottom and/or sides rails of the board and the water, and a comfortable and non-slip surface for the upper skin of the board. Although not performance related, body boards and kick boards have included additional layers of skin material to provide various artistic designs and logos. Body boards and kick boards have been manufactured using a variety of multiple step lamination processes all having the disadvantages of slow and unreliable production capacities and expensive and unpredictable production costs.

### SUMMARY OF THE INVENTION

One object of the present invention was to develop a simple and cost effective machine and process for manufacturing low and/or high performance body boards and kick boards.

The present invention is a machine and process for manufacturing recreation articles such as body boards and kick boards.

The present invention is a machine and process for manufacturing an article such as a body board having a pre-shaped core member having a top surface and a bottom surface, a top skin having a top and bottom surfaces, a perimeter portion, and a perimeter edge, and a bottom skin having a perimeter portion. In one embodiment, the machine of the present invention comprises a first mold halve having a lower surface and a second mold halve having a lower surface and a plurality of side walls extending upward from the bottom surface. The second mold further comprising at least one seam member engaged with each side surface. The machine further comprises a control unit for opening and closing the first and second mold halves. In operation, when the first and second molds are closed, the top surface of the pre-defined core member is bonded to the top skin, the perimeter portion of the top skin is caused to compress and bond with the side rails of the pre-defined core member, and the perimeter edge of the top skin is caused to compress and bond to the perimeter portion of the bottom skin to form a seam.

In a first embodiment, the process of the present invention comprises the steps of: (1) providing a first mold halve having a lower surface; (2) providing a second mold halve; (3) opening the first and second mold halves; (4) positioning in the first mold halve a pre-shaped core member having a top surface, a bottom surface having a bottom skin bonded thereto, and side rails; (5) positioning a top skin having an inner and outer surface in spaced relationship to the lower surface of the first mold halve; (6) heating, at substantially the same time, the top surface of the pre-shaped core member and the inner surface of the top skin; (7) closing the first and second mold halves; (8) compressing the top skin to the top surface and side rails of the pre-shaped core member; and (9) opening the upper and lower mold halves to remove the article.

### BRIEF DESCRIPTION OF THE DRAWINGS

The following detailed description of the invention will be more fully understood with reference to the accompanying drawings in which:

FIG. 1 is an exploded view of a first embodiment of the machine of the present invention;

FIG. 2 is a block diagram showing a first embodiment of the process of the present invention;

FIG. 3 is an exploded view of a second embodiment of the machine of the present invention; and

FIG. 4 is a block diagram showing a second embodiment of the process of the present invention.

### DETAILED DESCRIPTION OF THE PREFERRED EMBODIMENTS

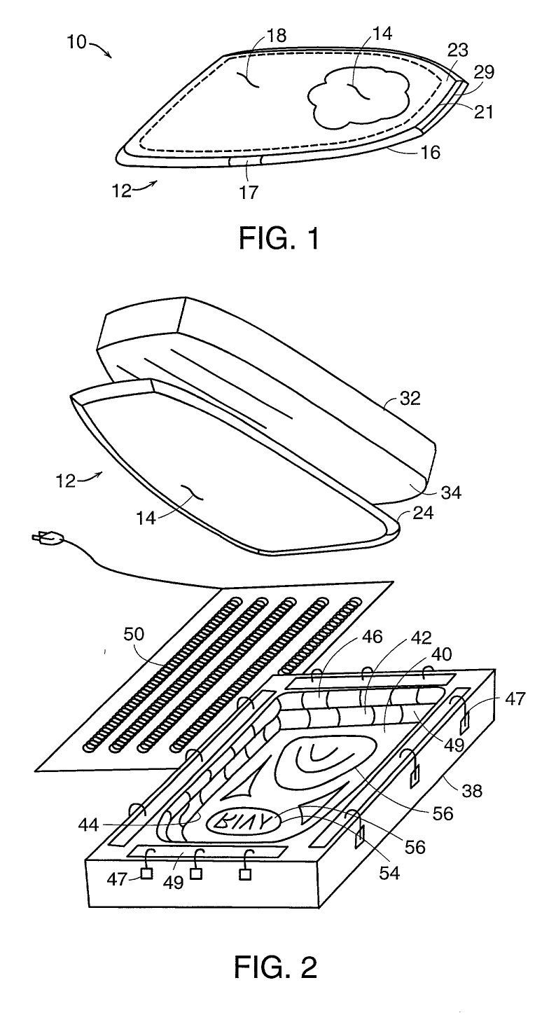

Referring to FIG. 1, wherein an article 10 such as a body board or a kick board manufactured by the machine and process of the present invention generally comprises a pre-shaped core member 12 having a top surface 14 and a bottom surface 18. The article further comprises a top skin 18 having an outer surface and an inner surface 22. The top skin 18 is further defined by a perimeter portion 21 and a perimeter edge 23. The article 10 further comprises a bottom skin 24 having an outer surface 26 and an inner surface 28. The bottom skin 24 is further defined by a perimeter portion 27. The pre-shaped core member 12 and the top and bottom skins 18 and 24 may be made from a variety of commonly known and available polymer based materials such as extruded polyethylene (PE). By way of example only, the pre-shaped core member 12 and top skin 18 are preferably made from a sheet of low density cellular foam PE to provide a soft and comfortable material for the person to ride on. The bottom skin 24 is preferably made from a sheet of high density hard PE having slick enhancing additives to provide during using a slick surface having a low drag coefficient between the bottom skin 16 and a water medium 18 such as an ocean or swimming pool.

Referring to FIG. 2, wherein the machine 30 of the first embodiment generally comprises a first mold halve 32 having a lower surface 34 and a plurality of sidewalls 34. The machine 30 further comprises a second mold halve 38 having a lower surface 40 and a plurality of side walls 42 extending upward from the bottom surface 40. Each of the sidewalls 42 comprise a lower side wall portion 44 extending upward from the lower surface 40 and an upper side wall portion 46. The upper side wall portion 46 is shaped in the form of a smooth protrusion or seam member 48 extending outward of the lower side wall portion 44 to. The lower surface of the second mold halve 38 may comprise an embossing member 54. The embossing member 54 may comprise one or more protrusions 56 extending upward from the lower surface 40 of said second mold halve 38. The first and second mold halves 32 and 38 may be oriented and open and close in a variety of manners. In the embodiment shown, the second mold halve 38 is stationary with a frame structure 40 by a plate 62 and the first mold halve 32 is aligned and vertically moveable along and/or by one or more support rods 64 engaged with the frame structure 38 and corresponding hydraulics (not shown).The second mold halve 38 further comprises a plurality of recess or cavities 49 disposed at the uppermost portion and about the perimeter of second mold halve. The top skin 18 is retained in the second mold halve 38 by the use of clamps or hooks 47 which engage with the top skin 18 and the recesses 49. The machine 30 further comprising a first heating element 50 moveable from a first position adapted to heat the top surface 14 of the pre-shaped core member 12 and the inner surface 22 of the top skin 18 for a first pre-defined period of time to a second position where the first heating element 50 is removed from the pre-shaped core member 12 and the top skin 18.

In the embodiment shown, the first heating element 50 is a resistive coil based heating unit which may be positioned by one of more support arms (not shown). The second mold halve 38 may further heat and cooling means (not shown) such as heated and cooled water flow, to apply heating and cooling, if necessary, to bottom surface 40 of the second mold halve 38 to enhance embossing design and final forming and cooling. The machine 10 may further comprise a control unit 58 to control the overall operation of the machine 10, including the operation of the first and second mold halves 28 and 32 and the first heating element 50. In operation, when the first and second mold halves 32 and 38 are closed, the top surface 14 of the pre-shaped core member 12 is bonded to the top skin 18 with desired embossing, and the upper side wall portion 46 or seam member 48 causes the perimeter portion 21 of the top skin 18 to compress and bond with the side rails 17 of the pre-shaped core member 12, and thereafter the perimeter edge 23 of the top skin 18 is caused to compress and bond to the perimeter portion 27 of the bottom skin 24 to form a seam 29. Alternatively, the upper side wall portion 46 or seam member 48 may cause the perimeter edge 23 of the top skin 18 to compress and bond with the side rails 17 of the pre-shaped core member 12 (having the bottom skin 24 already bonded thereto) to form a seam 29. The side rails 17 of the pre-shaped cor member 12 may be tapered such that the width of the top surface 14 of the pre-shaped core member 12 is smaller than the bottom surface 16 of the pre-shaped core member 12. The width of the top surface 14 should be small enough to allow insertion of the pre-shaped core member 12 into the second mold 38. Alternatively to a stationary upper side wall portion 46 or seam member 48, the upper side wall portion 46 may be rotatable from a first or open position to a second or closed position where it causes where it causes the perimeter portion 21 of the top skin 18 to compress and bond with the side rails 17 of the pre-shaped core member 12, and thereafter the perimeter edge 23 of the top skin 18 is caused to compress and bond to the perimeter portion 27 of the bottom skin 24 to form a seam 29. Alternatively, the moveable or rotatable upper side wall portion 46 or seam member 48 may cause the perimeter edge 23 of the top skin 18 to compress and bond with the side rails 17 of the pre-shaped core member 12 (having the bottom skin 24 already bonded thereto) to form a seam 29. The first and second mold halves 32 and 38 may be made from a variety of materials and processes, including casting, machining, and/or extrusion operations using metal and/or polymer materials.

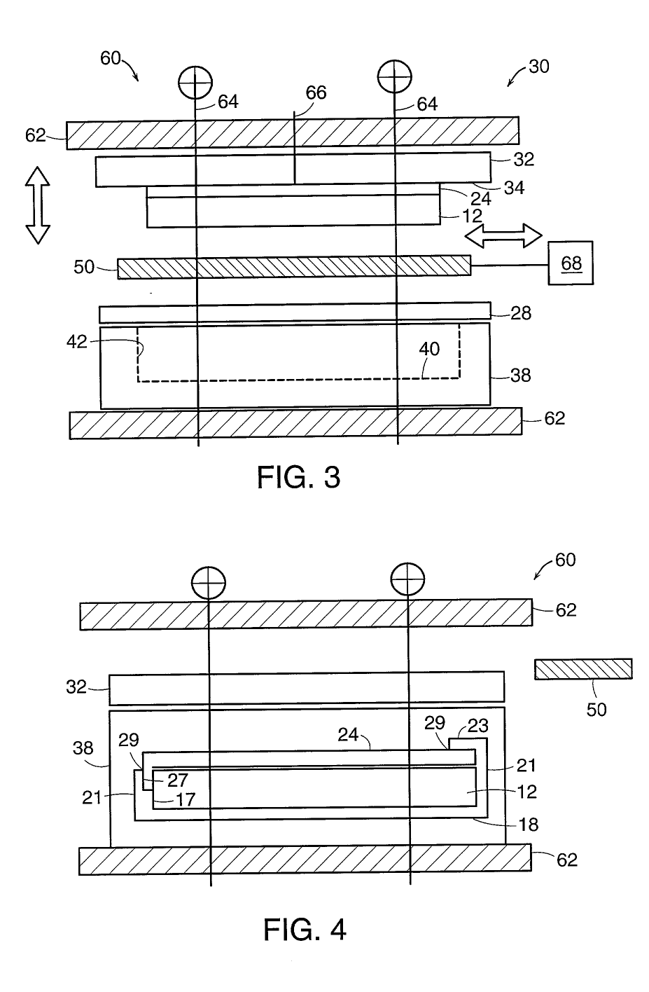

Referring to FIG. 3, wherein a first embodiment of the process of the present invention is shown. As indicated by block 300, the process comprises a step of providing a first mold halve having a lower surface. As indicated by block 302, the process further comprises a step of providing a second mold halve. As indicated by block 304, the process further comprises the step of opening the first and second mold halves. As indicated by block 306, the process further comprises the step of positioning in the first mold halve a pre-shaped core member having a top surface, a bottom surface having a bottom skin bonded thereto, and side rails. As indicated by block 308, the process further comprises the step of positioning a top skin having an inner and outer surface in spaced relationship to the lower surface of the first mold halve. As indicated by block 310, the process further comprises the step of heating, at substantially the same time, the top surface of the pre-shaped core member and the inner surface of the top skin. As indicated by block 312, the process further comprises the step of closing the first and second mold halves. As indicated by block 314, The process further comprises the step of compressing the top skin to the top surface and side rails of the pre-shaped core member. As indicated by block 316, the process further comprises the step of opening the upper and lower mold halves to remove the article. Although not shown in the drawings, the process may further comprise the step of embossing a marking onto the top skin 18 and the top surface 14 of the pre-shaped core member 12. The process may further comprises of positioning the first heating element 50 between the top surface 14 of the pre-shaped core member 12 and the top skin 18 for a first pre-defined period of time and removing the first heating 50 upon expiration of the first pre-defined period of time. The process may further comprise the step of moving the first mold halve into engagement with the second mold halve for a second pre-defined period of time. The process may further comprise the step of forcing the perimeter portion 21 of the top skin 18 to overlap the side rails 17 of the pre-shaped core member 12 and thereafter compress and bond the perimeter edge 23 of the top skin 18 to the perimeter portion 27 of the bottom skin 24. Alternatively, the process may include the upper side wall portion 46 or seam member 48 to cause the perimeter edge 23 of the top skin 18 to compress and bond with the side rails 17 of the pre-shaped core member 12 (having the bottom skin 24 already bonded thereto) to form a seam 29. The process may further comprise the step of trimming the exposed perimeter of the predefined core material 12 to the shape of the second mold 38. The process may further comprise the step of applying a shape to the exposed perimeter of the predefined core material 12 corresponding to the shape of the second mold 38. The steps of positioning in the first mold halve a pre-shaped core member 12 and the step of positioning a top skin 18 having an inner and outer surface 20 and 22 in spaced relationship to the lower surface 40 of the second mold halve 38 occur at substantially the same time.

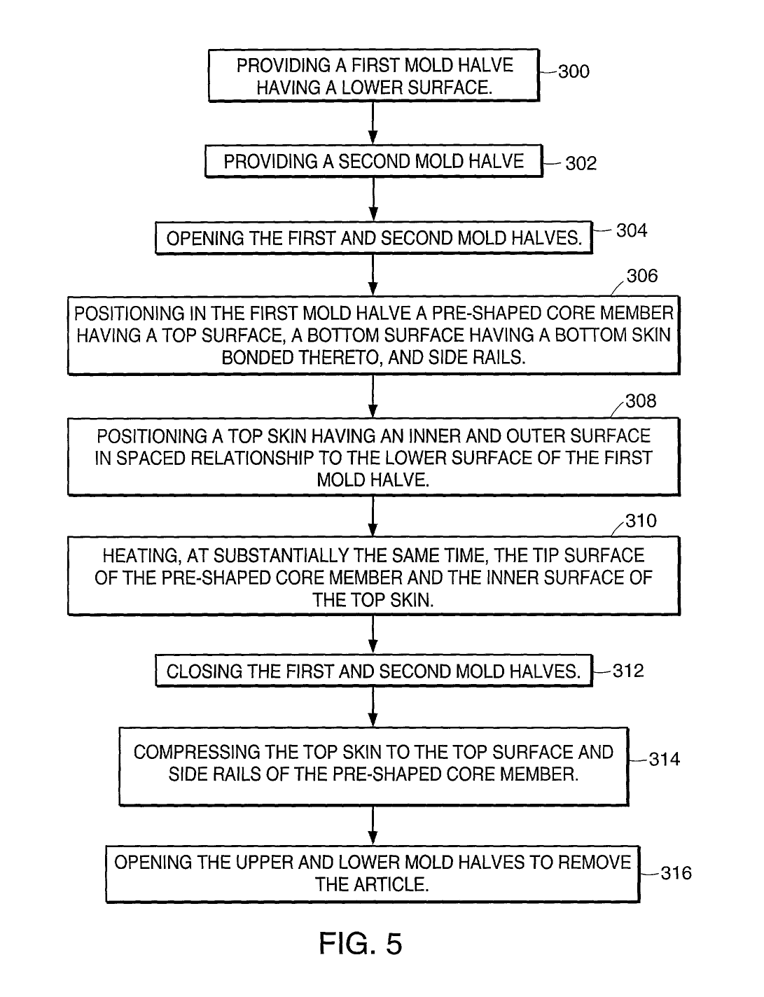

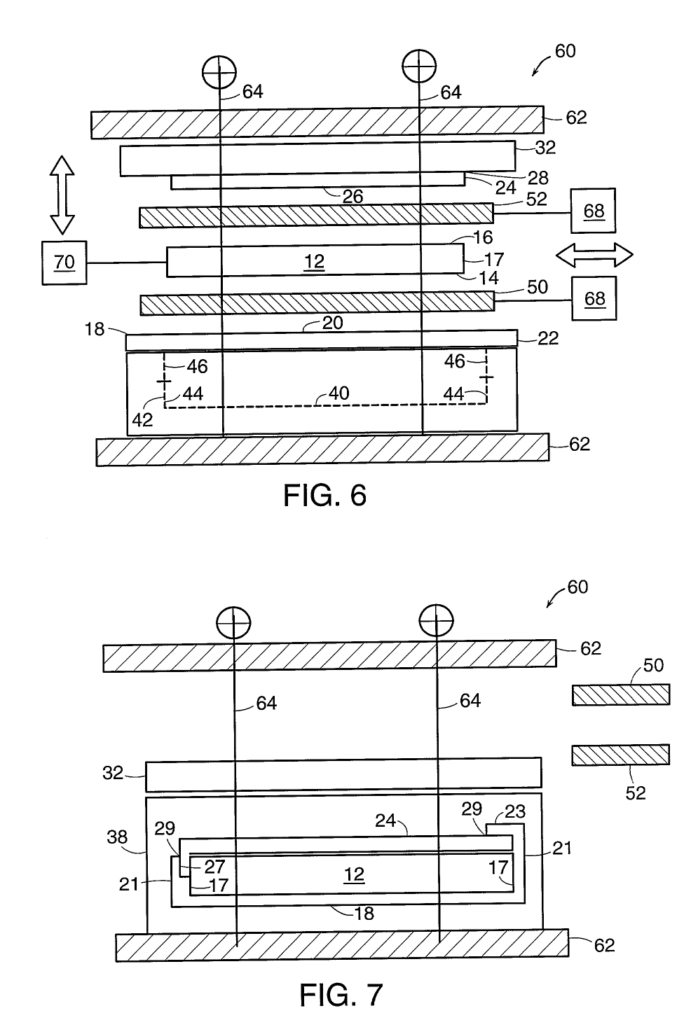

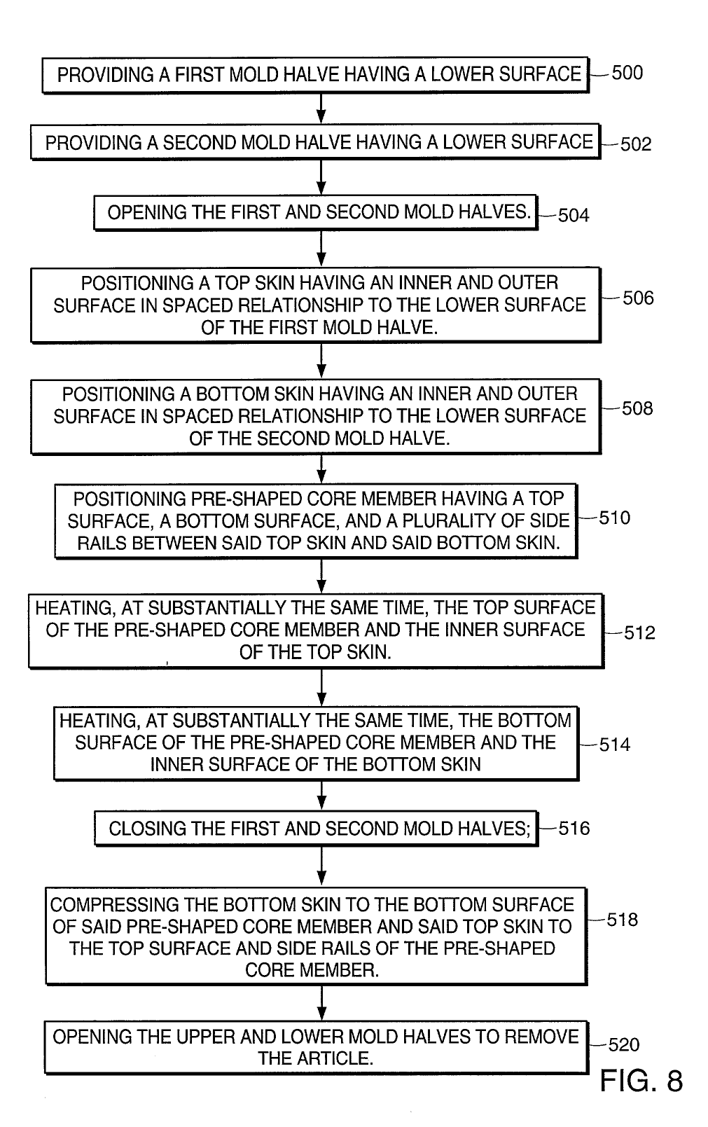

Referring to FIG. 4, wherein the machine 30 of a second embodiment is shown. The machine 30 of the second embodiment is similar to the machine 30 of the first embodiment except that the bottom skin 24 is applied as part of the operation of the machine 30 rather than being pre-laminated to the top surface 14 of the pre-shaped core member 12. The machine 30 of the second embodiment generally comprises a first mold halve 32 having a lower surface 34 and a plurality of sidewalls 34. The machine 30 further comprises a second mold halve 38 having a lower surface 40 and a plurality of side walls 42 extending upward from the bottom surface 40. Each of the sidewalls 42 comprise a lower side wall portion 44 extending upward from the lower surface 40 and an upper side wall portion 46. The upper side wall portion 46 is shaped in the form of a smooth protrusion or seam member 48 extending outward of the lower side wall portion 44 to. The lower surface of the second mold halve 38 may comprise an embossing member 54. The embossing member 54 may comprise one or more protrusions 56 extending upward from the lower surface 40 of said second mold halve 38. The first and second mold halves 32 and 38 may be oriented and open and close in a variety of manners. In the embodiment shown, the second mold halve 38 is stationary with a frame structure 60 and the first mold halve 32 is aligned and vertically moveable along and/or by one or more support rods 64 engaged with the frame structure 60 and corresponding hydraulics (not shown). Unlike the first embodiment, the top skin 18 is retained in the first mold halve 32 by the use of clamps or hooks 47 which engage with the bottom skin 18 and the recesses 49. Similarly, the top skin 18 is retained in the second mold halve 38 by the use of clamps or hooks 47 which engage with the top skin 18 and the recesses 49. The machine 10 further comprises a pre-shaped core member 12 which is suspended and/or positioned between the top and bottom skins 18 and 24 by a support mechanism 70.The machine 30 further comprising a first element 50 moveable by a guide or rail assembly 68 from a first position adapted to heat the top surface 14 of the pre-shaped core member 12 and the inner surface 22 of the top skin 18 for a first pre-defined period of time to a second position where the first heating element 50 is removed from the pre-shaped core member 12 and the top skin 18. In the embodiment shown, the first heating element 50 is a resistive coil based heating unit which may be positioned by a rail and guide unit 68. The second mold halve 38 may further heat and cooling means (not shown) such as heated and cooled water flow, to apply heating and cooling, if necessary, to bottom surface 40 of the second mold halve 38 to enhance embossing design and final forming and cooling. the machine 10 The machine 10 may further comprise a control unit 58 to control the overall operation of the machine 10, including the operation of the first and second mold halves 28 and 32 and the first heating element 50. In operation, when the first and second mold halves 32 and 38 are closed, the bottom skin 24 is compressed and bonded to the bottom surface 16 of the pre-shaped core member 12, and the top surface 14 of the pre-shaped core member 12 is bonded to the top skin 18 with desired embossing, and the seam member 48 causes the perimeter portion 21 of the top skin 18 to compress and bond with the side rails 17 of the pre-shaped core member 12, and thereafter the perimeter edge 23 of the top skin 18 is caused to compress and bond to the perimeter portion 27 of the bottom skin 24 to form a seam 29. Alternatively, the upper side wall portion 46 or seam member 48 may cause the perimeter edge 23 of the top skin 18 to compress and bond with the side rails 17 of the pre-shaped core member 12 (having the bottom skin 24 already bonded thereto) to form a seam 29.

Referring to FIG. 5, wherein a second embodiment of the process of the present invention is shown. As indicated by blocks 502 and 504, the process comprises the step of providing a first mold halve 32 having a lower surface 34 and sidewalls 36 and a second mold halve 38 having a lower surface 40 and side walls 42. As indicated by block 506, the process comprises the step of opening the first and second mold halves 32 and 38. As indicated by block 508, the process comprises the step of positioning a top skin 18 having an inner and outer surfaces 20 and 22 in spaced relationship to the lower surface 34 of the first mold halve 32. As indicated by block 510, the process comprises the step of positioning a bottom skin 24 having an inner and outer surface 26 and 28 in spaced relationship to the lower surface 40 of the second mold halve 38. As indicated by block 512, the process comprises the step of positioning a pre-shaped core member 12 having a top surface 14, a bottom surface 16, and a plurality of side rails 17 between said top skin and said bottom skin. As indicated by block 514, the process comprises the step of heating, at substantially the same time, the top surface of the pre-shaped core member and the inner surface of the top skin. As indicated by block 516, the process comprises the step of heating, at substantially the same time, the bottom surface of the pre-shaped core member and the inner surface of the bottom skin. As indicated by block 518, the process comprises the step of closing the first and second mold halves 32 and 38. As indicated by block 520, the process comprises the step of compressing the bottom skin 24 to the bottom surface 516 of the pre-shaped core member 12 and the top skin 18 to the top surface 14 and side rails 17 of the pre-shaped core member which may overlap and form a bonded seam with the perimeter portion 27 of the bottom skin 24 to form a seam 29. As indicated by block 522, the process comprises the step of opening the upper and lower mold halves 32 and 38 to remove the article. The process may further comprise the step of embossing a marking onto the top skin 18 and the top surface 14 of the pre-shaped core member 12. The process may further comprise the step of positioning a first heating element 50 between the top surface 14 of the pre-shaped core member 12 and the inner surface 22 of the top skin 18 for a first pre-defined period of time. The process may further comprise the step of positioning a second heating element 52 between the bottom surface 16 of the pre-shaped core member 12 and the inner surface 28 of the bottom skin 24 for a second pre-defined period of time. The process may further comprise the step of removing the first and second heating 50 and 52 elements upon expiration of the first and second pre-defined period of time. The process may further comprise the step of moving the first mold halve 32 into engagement with the second mold halve 38 for a third pre-defined period of time. The process may further comprise the step of forming the top skin 18 to the shape of the lower surface 40 of the first mold halve 38. The process may further comprise the step of forcing the perimeter portion 21 of the top skin to compress and bond to the side rails of the pre-shaped core member 12 and the perimeter edge 23 of the top skin 18 to bond to the perimeter portion 27 of the bottom skin 24.

The foregoing description is intended primarily for purposes of illustration. This invention may be embodied in other forms or carried out in other ways without departing from the spirit or scope of the invention. Modifications and variations still falling within the spirit or the scope of the invention will be readily apparent to those of skill in the art.

What is claimed is:

1. A process for manufacturing an article such as a body board by, the process comprising the steps of:
(a) providing a first mold halve having a lower surface;
(b) providing a second mold halve;
(c) opening the first and second mold halves;
(d) positioning in the first mold halve a pre-shaped core member having a top surface, a bottom surface having a bottom skin bonded thereto, and side rails;
(e) positioning a top skin having an inner and outer surface in spaced relationship to the lower surface of the first mold halve; and
(f) heating, at substantially the same time, the top surface of the pre-shaped core member and the inner surface of the top skin;
(g) closing the first and second mold halves;
(h) compressing the top skin to the top surface and side rails of the pre-shaped core member; and
(i) opening the upper and lower mold halves to remove the article.

2. The process of claim 1 further comprising the step of embossing a marking onto the top skin and the top surface of the pre-shaped core member;

3. The process of claim 2, wherein the step of heating, at substantially the same time, the top surface of the pre-defined core member and the top surface of the top skin comprises the step of positioning a heating element between the top surface of the pre-shaped core member and the inner surface of the top skin for a first pre-defined period of time.

4. The process of claim 3, further comprising the step of removing the heating element upon expiration of the first pre-defined period of time.

5. The process of claim 4, wherein the step of closing the first and second molds comprises the step of moving the first mold halve into engagement with the second mold halve for a second pre-defined period of time.

6. The process of claim 5, wherein said step of compressing the top skin to the lower surface of the pre-shaped core comprises the step of forcing the perimeter of the top skin to overlap the side rails of the pre-shaped core and seam with the bottom skin.

7. The process of claim 6, wherein said step of compressing the top skin to the lower surface of the pre-shaped core comprises the step of trimming the exposed perimeter of the predefined core material to the shape of the second mold.

8. The process of claim 7, wherein said step of compressing the top skin to the lower surface of the pre-shaped core comprises the step of applying a shape to the exposed perimeter of the predefined core material corresponding to the shape of the second mold

9. The process of claim 8, wherein said step of positioning in the first mold halve a pre-shaped core member and said step of positioning a top skin having an inner and outer surface in spaced relationship to the lower surface of the first mold halve occur at substantially the same time.

10. A machine for manufacturing an article such as a body board having a pre-shaped core member having a top surface and a bottom surface, a top skin having a top and bottom surfaces, a perimeter portion, and a perimeter edge, and a bottom skin having a perimeter portion, the machine comprises:
(a) a first mold halve having a lower surface;
(b) a second mold halve having a lower surface and a plurality of side walls extending upward from said bottom surface, said second mold further comprising at least one seam member engaged with each side surface;
(c) a control unit for opening and closing said first and second mold halves; 110 and
(d) whereby when the first and second molds are closed, the top surface of the pre-defined core member is bonded to the top skin, the perimeter portion of the top skin is caused to compress and bond with the side rails of the predefined core member, and the perimeter edge of the top skin is caused to compress and bond to the perimeter portion of the bottom skin to form a seam.

11. The machine of claim 10, further comprising a heating element moveable from a first position adapted to heat the top surface of the pre-shaped core member and the bottom surface of the top skin for a first pre-defined period of time to a second position where said heating element is removed from the pre-shaped core member and the top skin.

12. The machine of claim 11, wherein said second mold halve is stationary and said control united is adapted to move said first mold halve into engagement with said second mold halve.

13. The machine of claim 12, wherein said lower surface of said first mold cavity comprises an embossing member.

14. The machine of claim 13, wherein said embossing member comprises a protrusion extending upward from the lower surface of said second mold halve.

15. The machine of claim 14, wherein said plurality of sidewalls each have a lower portion and an upper portion.

16. The machine of claim 15, wherein said embossing member extends outward from said upper portion of each of said side walls.

17. A process for manufacturing an article such as a body board by, the process comprising the steps of:
(a) providing a first mold halve having a lower surface;
(b) providing a second mold halve having a lower surface;
(c) opening the first and second mold halves;
(d) positioning a top skin having an inner and outer surface in spaced relationship to the lower surface of the first mold halve;
(e) positioning a bottom skin having an inner and outer surface in spaced relationship to the lower surface of the second mold halve;
(f) positioning pre-shaped core member having a top surface, a bottom surface, and a plurality of side rails between said top skin and said bottom skin;
(g) heating, at substantially the same time, the top surface of the pre-shaped core member and the inner surface of the top skin;
(h) heating, at substantially the same time, the bottom surface of the pre-shaped core member and the inner surface of the bottom skin
(i) closing the first and second mold halves;
(j) compressing the bottom skim to the bottom surface of said pre-shaped core member and said top skin to the top surface and side rails of the pre-shaped core member; and
(k) opening the upper and lower mold halves to remove the article.

18. The process of claim 17, further comprising the step of embossing a marking onto the top skin and the top surface of the pre-shaped core member;

19. The process of claim 18, wherein the step of heating, at substantially the same time, the top surface of the pre-shaped core member and the top surface of the top skin comprises the step of positioning a first heating element between the top surface of the pre-shaped core member and the inner surface of the top skin for a first pre-defined period of time.

20. The process of claim 19, wherein the step of heating, at substantially the same time, the bottom surface of the pre-shaped core member and the inner surface of the bottom skin comprises the step of positioning a second heating element between the bottom surface of the pre-shaped core member and the inner surface of the bottom skin for a second pre-defined period of time.

21. The process of claim 20, further comprising the step of removing the first and second heating elements upon expiration of the first and second pre-defined period of time.

22. The process of claim 21, wherein the step of closing the first and second molds comprises the step of moving the first mold halve into engagement with the second mold halve for a third pre-defined period of time.

23. The process of claim 22, wherein said step of compressing the bottom skin to the lower surface of the pre-shaped core member comprises the step of forming the top skin to the shape of the lower surface of the first mold halve.

24. The process of claim 23, wherein said step of compressing the top skin to the top surface of the pre-shaped core member comprises the step of forcing the perimeter portion of the top skin to overlap the side rails of the pre-shaped core and the perimeter edge of the top skin to bond to the perimeter portion of the bottom skin.

25. The process of claim 24, wherein said step of compressing the top skin to the top surface of the pre-shaped core member comprises the step of trimming the exposed perimeter of the predefined core material to the shape of the second mold.

26. The process of claim 23, wherein said step of compressing the top skin to the lower surface of the pre-shaped core comprises the step of applying a shape to the exposed perimeter of the predefined core material corresponding to the shape of the second mold

27. The process of claim 24, wherein said step of positioning in the first mold halve a bottom skin and the step of positioning a top skin in the second mold halve occur at substantially the same time.

28. A machine for manufacturing an article such as a body board having a pre-shaped core member having a top surface and a bottom surface, a top skin having a top and bottom surfaces, a perimeter portion, and a perimeter edge, and a bottom skin having a perimeter portion, the machine comprises:
(a) a first mold halve having a lower surface and a plurality of side walls extending upward from said bottom surface, said first mold halve being adapted to retain the bottom skin;
(b) a second mold halve having a lower surface and a plurality of side walls extending upward from said bottom surface, said second mold halve being adapted to retain the top skin, said second mold further comprising at least one seam member engaged with each side surface;
(c) a first heating element adapted to be inserted and removed between the bottom skin and the bottom surface of the pre-shaped core member;
(d) a second heating element adapted to be inserted and removed between the top skin and the top surface of the pre-shaped core member;
(e) a control unit for opening and closing said first and second mold halves;
(f) whereby prior to closure of the first and second molds; and
(g) whereby when the first and second molds are closed, the bottom skin is compressed and bonded to the top surface of the pre-shaped core member, the top surface of the pre-defined core member is compressed and bonded to the top skin, the perimeter portion of the top skin is caused to compress and bond with the side rails of the pre-defined core member, and the perimeter edge of the top kin is compressed and bonded to the perimeter portion of the bottom skin to form a seam.

29. The machine of claim 28, wherein said first heating element is moveable from a first position adapted to heat the bottom surface of the pre-shaped core member and the bottom surface of the bottom skin for a first pre-defined period of time to a second position where said first heating element is removed from the pre-shaped core member and the bottom skin.

30. The machine of claim 29, wherein said second heating element is moveable from a first position adapted to heat the top surface of the pre-shaped core member and the bottom surface of the top skin for a second pre-defined period of time to a second position where said second heating element is removed from the pre-shaped core member and the top skin.

31. The machine of claim 30, wherein said second mold halve is stationary and said control united is adapted to move said first mold halve into engagement with said second mold halve.

32. The machine of claim 31, wherein said lower surface of said first mold cavity comprises an embossing member.

33. The machine of claim 32, wherein said embossing member comprises a protrusion extending upward from the lower surface of said second mold halve.

34. The machine of claim 33, wherein said plurality of sidewalls each have a lower portion and an upper portion.

35. The machine of claim 33, wherein said embossing member extends outward from said upper portion of each of said side walls.
